(19) United States
(12) Patent Application Publication
(10) Pub. No.: US 2021/0294927 A1
(43) Pub. Date: Sep. 23, 2021

(54) TAMPER DETECTION FOR HUB CONNECTED INTERNET OF THINGS DEVICES

(71) Applicant: CARRIER CORPORATION, PALM BEACH GARDENS, FL (US)

(72) Inventors: Guru Charan Kottur, Hyderabad, Telangana (IN); Aditya Swami, Hyderabad, Telangana (IN); Bhabani Sankar Nanda, Hyderabad, Telangana (IN)

(21) Appl. No.: 16/973,302

(22) PCT Filed: Dec. 11, 2019
(86) PCT No.: PCT/US2019/065682

§ 371 Date: Dec. 8, 2020

(30) Foreign Application Priority Data
Dec. 12, 2018 (IN) 201811046951

(51) Int. Cl. G06F 21/86; G06F 21/82; H04L 29/08

(52) U.S. Cl. CPC G06F 21/86; H04L 67/12; G06F 21/82

(57) ABSTRACT

Detecting tampering of Internet of Things (IoT) devices (410, 420, 430, 440) connected via an IoT hub (10). Each of the physical interfaces of the active IoT devices are monitored. Upon detecting tampering at a physical interface of one of the IoT devices, a first message is transmitted to the IoT hub regarding the tampering of the physical interface of the one IoT device. The IoT hub then broadcasts a second message to one or more of the other IoT devices.

### CROSS REFERENCE TO RELATED APPLICATIONS

This application claims the benefit of IN Application No. 201811046951, filed on Dec. 12, 2018, which is incorporated herein by reference in its entirety.

### BACKGROUND

The embodiments herein generally relate to tamper detection, and more particularly, to utilizing an Internet of Things (IOT) solution to prevent exploitation of IoT devices.

Physical device tampering typically goes undetected or unnoticed until a security hole has already exposed other devices. These devices can be easily accessed and tampered with by connecting hardware via the physical ports of these devices. What is needed is a way to detect and block unauthorized tampering of the devices via their physical ports.

### SUMMARY

According to a non-limiting embodiment, a method for detecting tampering of Internet of Things (IoT) devices connected via an IoT hub is provided. The method includes monitoring physical interfaces of a plurality of IoT devices, wherein each of the IoT devices comprises at least one physical interface. The method also includes detecting tampering at a physical interface of one of the plurality of IoT devices and transmitting a first messaging to the IoT hub regarding the tampering of the physical interface of the one IoT device. The method also includes broadcasting a second message to one or more other IoT devices of the plurality of IoT devices.

In addition to one or more of the features described herein, or as an alternative, further embodiments of the method may include wherein broadcasting a second message to one or more other IoT devices of the plurality of IoT devices includes broadcasting the second message to block access via physical interfaces of the one or more other IoT devices.

In addition to one or more of the features described herein, or as an alternative, further embodiments of the method may include wherein the physical interface of the one IoT device is a first type of physical interface and wherein broadcasting a second message to one or more other IoT devices of the plurality of IoT devices comprises broadcasting the second message to block access via the one or more other IoT devices having the first type of physical interfaces.

In addition to one or more of the features described herein, or as an alternative, further embodiments of the method may include wherein a controller of the one IoT device blocks access to the physical interface of the one IoT device where the tampering was detected.

In addition to one or more of the features described herein, or as an alternative, further embodiments of the method may include wherein each of the IoT devices provides a service for performing the monitoring of its own physical interfaces, and in response to the service detecting tampering, the service transmits the first message to the IoT hub.

In addition to one or more of the features described herein, or as an alternative, further embodiments of the method may include wherein a portion of the plurality of IoT devices are on a first network and another portion of the IoT devices are on a second network.

In addition to one or more of the features described herein, or as an alternative, further embodiments of the method may include wherein the one IoT device is part of the first network and the second message is broadcast only to other IoT devices of the first network.

In addition to one or more of the features described herein, or as an alternative, further embodiments of the method may include wherein the second message comprises an identification of the one IoT device and a type of physical interface where the tampering was detected.

In addition to one or more of the features described herein, or as an alternative, further embodiments of the method may include one or more other IoT devices of the plurality of IoT devices, in response to receiving the broadcasted second message, blocking access via physical interfaces similar to the physical interface of the one IoT device where tampering was detected.

According to another non-limiting embodiment, a system for detecting tampering of Internet of Things (IoT) devices connected via an IoT hub is provided. The system includes a processor coupled to a memory unit, wherein the processor is configured to execute program instructions. The program instructions include monitoring physical interfaces of a plurality of IoT devices, wherein each of the IoT devices comprises at least one physical interface. The program instructions also include detecting tampering at a physical interface of one of the plurality of IoT devices and transmitting a first messaging to the IoT hub regarding the tampering of the physical interface of the one IoT device. The program instructions also include broadcasting a second message to one or more other IoT devices of the plurality of IoT devices.

In addition to one or more of the features described herein, or as an alternative, further embodiments of the system may include wherein broadcasting a second message to one or more other IoT devices of the plurality of IoT devices comprises broadcasting the second message to block access via physical interfaces of the one or more other IoT devices.

In addition to one or more of the features described herein, or as an alternative, further embodiments of the system may include wherein the physical interface of the one IoT device is a first type of physical interface and wherein broadcasting a second message to one or more other IoT devices of the plurality of IoT devices comprises broadcasting the second message to block access via the one or more other IoT devices having the first type of physical interfaces.

In addition to one or more of the features described herein, or as an alternative, further embodiments of the system may include wherein the program instructions further comprise providing a service for performing the monitoring of physical interfaces, and in response to the service detecting tampering, the service transmitting the first message to the IoT hub.

In addition to one or more of the features described herein, or as an alternative, further embodiments of the system may include wherein a portion of the plurality of IoT devices are on a first network and another portion of the IoT devices are on a second network and wherein the one IoT device is part of the first network and the second message is broadcast only to other IoT devices of the first network.

In addition to one or more of the features described herein, or as an alternative, further embodiments of the system may include wherein the second message comprises an identification of the one IoT device and a type of physical interface where the tampering was detected.

In addition to one or more of the features described herein, or as an alternative, further embodiments of the system may include wherein the program instructions further comprise blocking access via physical interfaces, of the one or more other IoT devices of the plurality of IoT devices, similar to the physical interface of the one IoT device where tampering was detected in response to receiving the broadcasted second message.

According to another embodiment, a computer program product including a computer readable storage medium having program instructions embodied therewith, the program instructions executable by a computer processor to cause the computer processor to perform a method for detecting tampering of Internet of Things (IoT) devices connected via an IoT hub, comprising: monitoring physical interfaces of a plurality of IoT devices, wherein each of the IoT devices comprises at least one physical interface, detecting tampering at a physical interface of one of the plurality of IoT devices, transmitting a first messaging to the IoT hub regarding the tampering of the physical interface of the one IoT device, and broadcasting a second message to one or more other IoT devices of the plurality of IoT devices.

In addition to one or more of the features described herein, or as an alternative, further embodiments of the computer program product may include wherein broadcasting a second message to one or more other IoT devices of the plurality of IoT devices comprises broadcasting the second message to block access via physical interfaces of the one or more other IoT devices.

In addition to one or more of the features described herein, or as an alternative, further embodiments of the computer program product may further include providing a service for performing the monitoring physical interfaces, and in response to the service detecting tampering, the service transmitting the first message to the IoT hub.

In addition to one or more of the features described herein, or as an alternative, further embodiments of the computer program product may further include the one or more other IoT devices of the plurality of IoT devices, in response to receiving the broadcasted second message, blocking access via physical interfaces similar to the physical interface of the one IoT device where tampering was detected.

Additional features and advantages are realized through the techniques of the disclosure. For a better understanding of the disclosure with the advantages and the features, refer to the description and to the drawings.

### BRIEF DESCRIPTION OF THE DRAWINGS

The foregoing and other features, and advantages of the disclosure are apparent from the following detailed description taken in conjunction with the accompanying drawings, in which:

FIG. 1 depicts a cloud computing environment according to one or more embodiments of the present invention;

FIG. 2 depicts abstraction model layers of a cloud computer environment according to one or more embodiments of the present invention;

FIG. 3 depicts a block diagram illustrating an exemplary computer processing system that may be utilized to implement one or more embodiments of the present invention;

FIG. 4 depicts a block diagram illustrating an Internet of Things (IoT) hub connecting a plurality of active IoT devices according to exemplary embodiments of the present disclosure; and

FIG. 5 is a flow diagram illustrating a method for detecting tampering of IoT devices connected via an IoT hub according to exemplary embodiments of the present disclosure.

The diagrams depicted herein are illustrative. There can be many variations to the diagram or the operations described therein without departing from the spirit of the disclosure. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

In the accompanying figures and following detailed description of the disclosed embodiments, the various elements illustrated in the figures are provided with two or three digit reference numbers. With minor exceptions, the leftmost digit(s) of each reference number correspond to the figure in which its element is first illustrated.

### DETAILED DESCRIPTION

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computer systems and specific computer programs to implement the various technical features described herein are well known. Accordingly, in the interest of brevity, many conventional implementation details are only mentioned briefly herein or are omitted entirely without providing the well-known system and/or process details.

The present invention may be implemented in one or more embodiments using cloud computing. Nonetheless, it is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

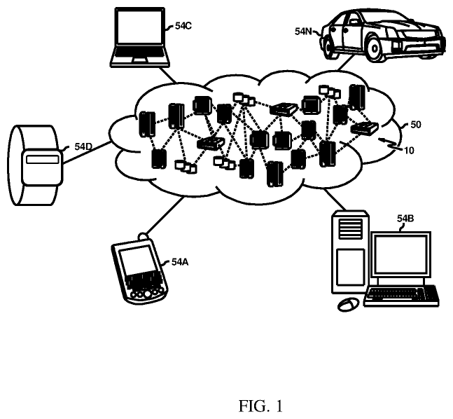

Referring now to FIG. 1, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, wearable electronic device 54D, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof.

The cloud computing environment 50 offers infrastructure, platforms and/or software as services for which a cloud consumer does not need to maintain resources on a local computing device. In one or more embodiments, one or more nodes 10 may be configured as an Internet of Things (Iot) hub 10.

It is understood that the types of IoT devices such as computing devices 54A-54N shown in FIG. 1 are intended to be illustrative only and that the IoT hub 10 and cloud computing environment 50 can communicate with any type of computerized device over any type of network and/or network addressable connection (e.g., using a web browser).

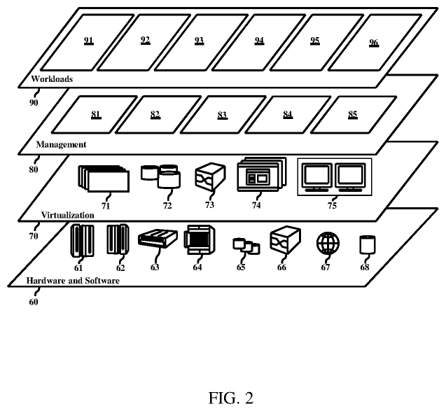

Referring now to FIG. 2, a set of functional abstraction layers provided by cloud computing environment 50 is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73; including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and learning model processing 96, for performing one or more processes for performing monitoring of physical interfaces and for receiving, generating, transmitting and management of messages for detecting and propagating information about tampering as described herein.

The cloud computing environment 50 may also include a device layer which includes physical and/or virtual devices, embedded with and/or standalone electronics, sensors, actuators, and other objects to perform various tasks in the cloud computing environment 50. Each of the devices in the device layer incorporates networking capability to other functional abstraction layers such that information obtained from the devices may be provided thereto, and/or information from the other abstraction layers may be provided to the devices. In one embodiment, the various devices inclusive of the device layer may incorporate a network of entities collectively known as the “internet of things” (IoT). Such a network of entities allows for intercommunication, collection, and dissemination of data to accomplish a great variety of purposes, as one of ordinary skill in the art will appreciate.

The device layer may include, for example, one or more computing devices, sensors, actuators, “learning” thermostats with integrated processing, and networking electronics, cameras, controllable household outlet/receptacles, and controllable electrical switches. Other possible devices may include, but are not limited to various additional sensor devices, networking devices, electronics devices (such as a remote control device), additional actuator devices, so called “smart” appliances such as a refrigerator or washer/dryer, and a wide variety of other possible interconnected objects.

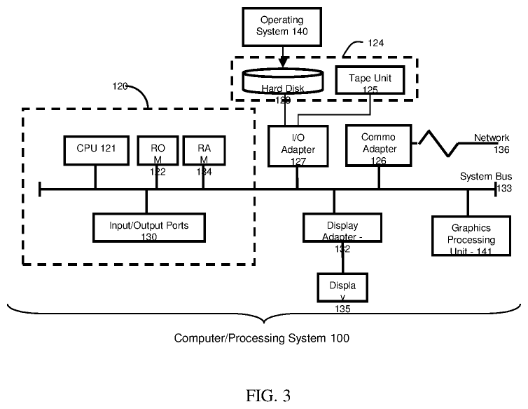

Referring to FIG. 3, there is shown an embodiment of a processing system, commonly referred to as a computer device or system 100, which communicates over a communications network to one or more nodes 10 of the cloud computing environment 50 for implementing the teachings herein. The computer system 100 has one or more central processing units (processors) 121. Processors 121 are coupled to system memory (RAM) 134 and various other components via a system bus 133. Read only memory (ROM) 122 is also coupled to the system bus 133 and may include a basic input/output system (BIOS) with physical input/output ports 130 capable of sending output data and receiving input data. The physical input/output ports 130 may be, for example, serial ports such as serial peripheral interface (SPI) and serial protocol interface (I2C) ports, parallel ports, USB ports, HDMI, Ethernet, PS2 ports, infrared ports, Bluetooth ports, Firewire, modem or phone ports, and the like. Input/output ports may alternatively be referred to as interfaces. In one or more embodiments, the one or more processors 121, ROM 122, RAM 134 and input/output ports 130 define a microcontroller 120 which controls certain functions of the computer system 100.

Still referring to FIG. 3, the microcontroller 120 may further include an input/output (I/O) adapter 127 and a network adapter 126 coupled to the system bus 133. I/O adapter 127, for example, may be a small computer system interface (SCSI) adapter that communicates with a hard disk 123 and/or tape storage drive 125 or any other similar component. I/O adapter 127, hard disk 123, and tape storage device 125 are collectively referred to herein as mass storage 124.

Operating system 140 for execution on the computer system 100 may be stored in mass storage 124. However, the operating system 140 may also be stored in RAM 134 of the computer system 100. In one embodiment, a portion of RAM 134 and mass storage 124 collectively store the operating system 140 to coordinate the functions of the various components shown in FIG. 3. Operating systems according to embodiments of the present invention include, for example, UNIX™, Linux™, Microsoft XP™ AIX™ and IBM's i5/OS™.

A network adapter 126 interconnects bus 133 with an outside network 136 enabling the computer system 100 to communicate with other such systems. A screen (e.g., a display monitor) 135 is connected to system bus 133 by display adaptor 132, which may include a graphics adapter to improve the performance of graphics intensive applications and a video controller. In one embodiment, adapters 127, 126, and 132 may be connected to one or more I/O busses that are connected to system bus 133 via an intermediate bus bridge (not shown). Suitable I/O buses for connecting peripheral devices such as hard disk controllers, network adapters, and graphics adapters typically include common protocols, such as the Peripheral Component Interconnect (PCI).

In exemplary embodiments, the computer system 100 includes a graphics processing unit 141. Graphics processing unit 141 is a specialized electronic circuit designed to manipulate and alter memory to accelerate the creation of images in a frame buffer intended for output to a display. In general, graphics processing unit 141 is very efficient at manipulating computer graphics and image processing and has a highly parallel structure that makes it more effective than general-purpose CPUs for algorithms where processing of large blocks of data is done in parallel.

Thus, as configured in FIG. 3, the computer system 100 includes processing capability in the form of the processor 121, storage capability including RAM 134 and mass storage 124. Additional input/output devices may be connected to the system bus 133 via a user interface adapter or a display adapter 132. A keyboard, a mouse, and a speaker, for example, may all be all interconnected to bus 133 via user an interface adapter, which may include, for example, a Super I/O chip integrating multiple device adapters into a single integrated circuit.

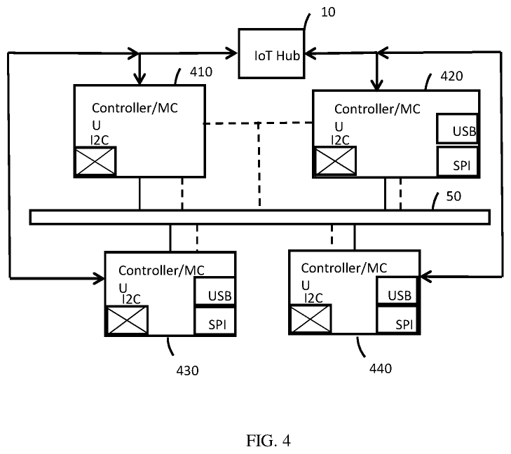

FIG. 4 depicts an exemplary embodiments of a computing node in the form of an IoT hub 10 hosted in a cloud computing environment 50. The IoT hub 10, for example, is managed service that provides central messaging for b-directional communications between IoT devices such as microcontrollers 410, 420, 430 and 440. For example, one or more of the microcontrollers 410, 420, 430 and 440 may correspond with the microcontroller 120 of the computer system 100 or another device of the device layer of the cloud computing environment 50.

In embodiments herein, the IoT hub 10 may also provide a physical interface monitoring service for monitoring the physical interfaces of IoT devices for tampering and exposure to security risks. All or part of the monitoring service may also be performed from the active IoT devices of the IoT hub 10. Therefore, in one or more embodiments, one or more of the microcontrollers 410, 420, 430 and 440 may include the monitoring service for monitoring the physical interfaces of each of the microcontrollers 410, 420, 430 and 440. For example, microcontroller 410 with the monitoring service can monitor its own I2C port, microcontroller 420 with the monitoring service can monitor its own I2C, USB and SPI ports, microcontroller 430 with the monitoring service can monitor its own I2C, USB and SPI ports, and the microcontroller 440 with the monitoring service can monitor its own I2C, USB and SPI ports.

In accordance with one or more embodiments, when an active IoT device such as microcontroller 410 detects tampering or attempts to exploit its I2C port, the microcontroller 410 via the monitoring service transmits a message to the IoT hub 10 regarding the detected tampering. The message may include identification of the microcontroller 410 and the physical interface that was tampered with. Upon the IoT hub 10 receiving the message from the microcontroller 410 that its I2C port was tampered with, a second message is generated by the IoT hub and published or broadcast to one or more of the other microcontrollers 420, 430 and 440. For illustration purposes, a dashed line is shown between the microcontrollers 410, 420, 430 and 440 indicating transmission and receipt of the second message. The second message may also include identification of the microcontroller 410 and the interface that was tampered with in order to propagate information about the tampering. In one embodiment, if one or more IoT devices are on separate networks, then the second message is sent at least to the other IoT devices on the network with the IoT device that was tampered with. In another embodiment, the second message is sent to the other IoT devices on other or multiple networks.

In one or more embodiments, the second message is sent to the other IoT devices that have the same or similar type of physical interface that was originally tampered with. For example, in FIG. 3, the I2C port of microcontroller 410 was tampered with and so the other microcontrollers 420, 430 and 440 with I2C ports will receive the second message.

In one or more embodiments, the IoT device where tampering of a physical interface was detected, such as microcontroller 410, can itself lock down or block access via the physical interface where the tampering was detected. For illustration purposes, in FIG. 4 the I2C port of the microcontroller 410 includes an “X” to indicate is has been blocked. Also, the second message, for example, can include an instruction to lock down or block access via one or more physical interfaces of the other IoT devices which receive the second message. For example, when the microcontrollers 420, 430 and 440 receive the second message, in response they could block access to their I2C ports. The I2C ports of the microcontrollers 420, 430 and 440 In FIG. 4 also include an “X” therethrough as a result of receiving the second message. Alternatively, the second message could include instructions to block access to the same or similar type of physical interfaces as the type of physical interface where tampering was detected or, in addition, different types of physical interfaces. Also, in one or more embodiments, the IoT hub 10 may permit IoT devices to be configured into one or more groups and the second message can be broadcast to one or more of the groups in order to lock down the one or more groups.

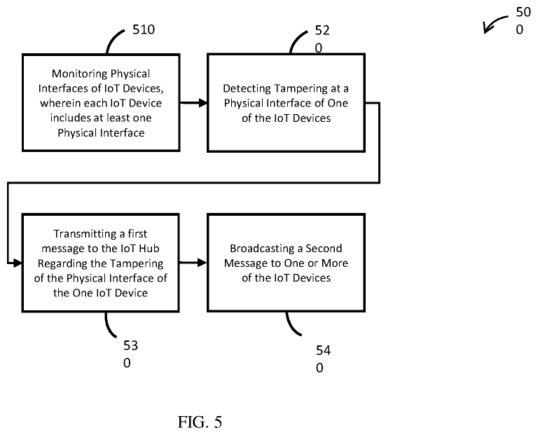

Turning to FIG. 5, one or more embodiments may include a method 500 for detecting tampering of Internet of Things (IoT) devices connected via an IoT hub. The flow diagram of FIG. 5 illustrates the method 500 that includes process block 510 for monitoring physical interfaces of a plurality of IoT devices, wherein each of the IoT devices comprises at least one physical interface. The method 500 also includes process block 520 for detecting tampering at a physical interface of one of the plurality of IoT devices and process block 530 for transmitting a first messaging to the IoT hub regarding the tampering of the physical interface of the one IoT device. The method 500 also includes broadcasting a second message to one or more other IoT devices of the plurality of IoT devices.

The method 500 may also include broadcasting the second message to block access via physical interfaces of the one or more other IoT devices. Also, the method 500 may include broadcasting the second message to block access via the one or more other IoT devices having a particular type of physical interface. The method 500 may also include a controller of the one IoT device blocking access to the physical interface of the one IoT device where the tampering was detected. The method 500 may also include where each of the IoT devices provides a service for performing the monitoring of its own physical interfaces, and in response to the service detecting tampering, the service transmits the first message to the IoT hub. The method 500 may also include where a portion of the plurality of IoT devices are on a first network and another portion of the IoT devices are on a second network and where the one IoT device is part of the first network and the second message is broadcast only to other IoT devices of the first network. The method 500 may also include the one or more other IoT devices of the plurality of IoT devices, in response to receiving the broadcasted second message, blocking access via physical interfaces similar to the physical interface of the one IoT device where tampering was detected. The method 500 may also include where the second message includes an identification of the one IoT device and a type of physical interface where the tampering was detected. The method 500 may also include providing a notification to an administrator of the IoT hub that an attempt was made to exploit a particular physical interface of a particular IoT device. A notification may also include what other IoT devices have blocked physical interfaces as a result of detected tampering at one particular IoT device.

Various technical benefits are achieved using the system and methods described herein, including the capability of providing enhanced performance for applications with exclusive access to the co-processors while also allowing applications that do not need performance access to accelerators when shared access is available. In this manner, the computing device can realize performance gains through the use of co-processors in the system, thereby improving overall processing speeds.

The computer program product may include a computer readable storage medium (or media) having computer readable program instructions thereon for causing a processor to carry out aspects of the present disclosure. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for detecting tampering of Internet of Things (IoT) devices connected via an IoT hub, the method comprising:
monitoring physical interfaces of a plurality of IoT devices, wherein each of the IoT devices comprises at least one physical interface;
detecting tampering at a physical interface of one of the plurality of IoT devices;
transmitting a first messaging to the IoT hub regarding the tampering of the physical interface of the one IoT device; and
broadcasting a second message to one or more other IoT devices of the plurality of IoT devices.

2. The method of claim 1 wherein broadcasting a second message to one or more other IoT devices of the plurality of IoT devices comprises broadcasting the second message to block access via physical interfaces of the one or more other IoT devices.

3. The method of claim 1 wherein the physical interface of the one IoT device is a first type of physical interface and wherein broadcasting a second message to one or more other IoT devices of the plurality of IoT devices comprises broadcasting the second message to block access via the one or more other IoT devices having the first type of physical interfaces.

4. The method of claim 1 wherein a controller of the one IoT device blocks access to the physical interface of the one IoT device where the tampering was detected.

5. The method of claim 1 wherein each of the IoT devices provides a service for performing the monitoring of its own physical interfaces, and in response to the service detecting tampering, the service transmits the first message to the IoT hub.

6. The method of claim 1 wherein a portion of the plurality of IoT devices are on a first network and another portion of the IoT devices are on a second network.

7. The method of claim 6 wherein the one IoT device is part of the first network and the second message is broadcast only to other IoT devices of the first network.

8. The method of claim 1 wherein the second message comprises an identification of the one IoT device and a type of physical interface where the tampering was detected.

9. The method of claim 1 further comprising the one or more other IoT devices of the plurality of IoT devices, in response to receiving the broadcasted second message, blocking access via physical interfaces similar to the physical interface of the one IoT device where tampering was detected.

10. A system for detecting tampering of Internet of Things (IoT) devices connected via an IoT hub, the system comprising:
a processor coupled to a memory unit, wherein the processor is configured to execute program instructions comprising:
monitoring physical interfaces of a plurality of IoT devices, wherein each of the IoT devices comprises at least one physical interface;
detecting tampering at a physical interface of one of the plurality of IoT devices;
transmitting a first messaging to the IoT hub regarding the tampering of the physical interface of the one IoT device; and
broadcasting a second message to one or more other IoT devices of the plurality of IoT devices.

11. The system of claim 10 wherein broadcasting a second message to one or more other IoT devices of the plurality of IoT devices comprises broadcasting the second message to block access via physical interfaces of the one or more other IoT devices.

12. The system of claim 10 wherein the physical interface of the one IoT device is a first type of physical interface and wherein broadcasting a second message to one or more other IoT devices of the plurality of IoT devices comprises broadcasting the second message to block access via the one or more other IoT devices having the first type of physical interfaces.

13. The system of claim 10 wherein the program instructions further comprise providing a service for performing the monitoring of physical interfaces, and in response to the service detecting tampering, the service transmitting the first message to the IoT hub.

14. The system of claim 10 wherein a portion of the plurality of IoT devices are on a first network and another portion of the IoT devices are on a second network and wherein the one IoT device is part of the first network and the second message is broadcast only to other IoT devices of the first network.

15. The system of claim 10 wherein the second message comprises an identification of the one IoT device and a type of physical interface where the tampering was detected.

16. The system of claim 10 wherein the program instructions further comprise blocking access via physical interfaces, of the one or more other IoT devices of the plurality of IoT devices, similar to the physical interface of the one IoT device where tampering was detected in response to receiving the broadcasted second message.

17. A computer program product comprising a computer readable storage medium having program instructions embodied therewith, the program instructions executable by a computer processor to cause the computer processor to perform a method for detecting tampering of Internet of Things (IoT) devices connected via an IoT hub, comprising:
monitoring physical interfaces of a plurality of IoT devices, wherein each of the IoT devices comprises at least one physical interface;
detecting tampering at a physical interface of one of the plurality of IoT devices;
transmitting a first messaging to the IoT hub regarding the tampering of the physical interface of the one IoT device; and
broadcasting a second message to one or more other IoT devices of the plurality of IoT devices.

18. The computer program product of claim 17 wherein broadcasting a second message to one or more other IoT devices of the plurality of IoT devices comprises broadcasting the second message to block access via physical interfaces of the one or more other IoT devices.

19. The computer program product of claim 17 wherein the method further comprises providing a service for performing the monitoring physical interfaces, and in response to the service detecting tampering, the service transmitting the first message to the IoT hub.

20. The computer program product of claim 17 wherein the method further comprises the one or more other IoT devices of the plurality of IoT devices, in response to receiving the broadcasted second message, blocking access via physical interfaces similar to the physical interface of the one IoT device where tampering was detected.
